(19) United States
(12) Patent Application Publication
(10) Pub. No.: US 2008/0243697 A1
(43) Pub. Date: Oct. 2, 2008

(54) DIGITAL GAME DISTRIBUTION AND ROYALTY CALCULATION

(75) Inventors: Richard Irving, Kirkland, WA (US); Dax Hawkins, Kirkland, WA (US); David M. Ciuba, Redmond, WA (US); Jeffrey R. Bernhardt, Woodinville, WA (US); Manuel Bronstein, Redmond, WA (US); Gretchen Eichinger, Seattle, WA (US); Josh William Hutto, Kirkland, WA (US); Rohan K. Oommen, Kirkland, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/694,661

(22) Filed: Mar. 30, 2007

(51) Int. Cl. H04K 1/00

(52) U.S. Cl. 705/54; 705/16; 705/59

(57) ABSTRACT

Systems and methods of digitally distributing digital game content and tracking royalties for the digital game content may include a correlated title key, retail key, and license key. The a correlated title key, retail key, and license key may be used to generate a royalty rate. For example, a royalty rate may be generated based on the license key. Additionally, a royalty price may be generated based on the title key. Then, a royalty amount may be computed by multiplying the royalty rate and the royalty price. The royalty amount may be stored in a retailer account that corresponds to the retail key.

### CROSS REFERENCE TO RELATED APPLICATIONS

This application is related to the subject matter disclosed in U.S. patent application Ser. No. ______, Attorney Docket MSFT-5837/318559.01, filed on even date herewith and entitled “DIGITAL GAME DISTRIBUTION FOR GAMING DEVICES”, the disclosure of which is hereby incorporated by reference in its entirety.

### BACKGROUND

Digitally distributed content and devices for such digital content have become increasingly popular in recent years. For example, online music sales of digital music content have increased exponentially. Additionally, the sales of devices, for example, MP3 players or music servers for such digital music have also grown at tremendous rates. One reason for the success of both digital content and devices for such content may include the elimination of physical media such as CDs or DVDs. Now, a user of such a device may have the ability to store thousands of digital music files or video files, for example, on the device eliminating the need to insert physical media such as CDs, or DVDs, for example.

Unfortunately, some devices such as video game systems may be tied to physical media, because of the device's dependence upon retailers. For example, a video game system's primary channel of distribution is through retailers. Due to the cost of the system itself and market constraints on the purchase price, the retailer may not make a profit on the actual system. But, the retailer may make a profit on the physical media it sells that includes the video game software for the system. Thus, a retailer may be reluctant to sell a video game system without the ability to sell the physical media that includes the video game software for such a system. Because the device manufactures are dependent upon the retailers as their main channel of distribution and a bulk of the retailer's profit may be made off the physical media, digitally distributed digital game content may be perceived as a risk for both the device manufacturers and the retailers.

### SUMMARY

According to some embodiments, a retailer may receive a royalty amount corresponding to a digital game content distributed to a video game system. The retailer may be selected by a user of the video game system according to an example embodiment. Alternatively, the retailer may be tied to the retailer where the video game system may have been purchased. For example, the video game system may store the retailer where the system may have been purchased. When a user downloads or receives digital game content, a royalty amount may be calculated by the video game system or a digital game content management system. The royalty amount may then be paid to the retailer.

According to one embodiment, the royalty amount may be calculated by multiplying a royalty rate by a royalty base price. For example, a digital game content management system may receive a package of data information that includes a title key, a retail key, and a license key from a video game system. The digital game content management system may generate a royalty rate based on the license key. The license key may include licensing options or transaction options that may be used to compute the royalty rate. For example, a user of a video game system may rent a video game for a flat one-time fee. This transaction option of renting may be used to provide a royalty rate for rented games. Additionally, a user of a video game may only want a portion of the levels provided. This licensing option may be used to provide a royalty rate for partial level games. The digital game content management system may also provide a royalty base price based on the title key. For example, a title of a popular game may be entitled to a specified royalty base price greater than a title of a less popular game. The royalty amount may be calculated by multiplying the royalty rate and the royalty base price.

The system may store the royalty amount to a retailer account that corresponds to the retail key. For example, the retail key may include a unique identifier for a preferred retailer. The unique identifier may be mapped to the retailer account such that the retail key directs the royalty amount to an appropriate retailer account corresponding to the preferred retailer. The royalty amount may then be distributed to the retailer at the end of a predetermined period or an accounting period, for example.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 depicts an example embodiment of a video game system in communication with a digital content source and authentication system;

FIG. 2 depicts an example embodiment of a flow diagram that illustrates providing digital game content to a portable game system;

FIG. 3 depicts an example embodiment of a flow diagram that illustrates providing an electronic credential to a portable game system;

FIG. 4 depicts an example embodiment of an authentication system that may be adapted to generate and manage licensing rights of digital game content;

FIG. 5 depicts an example embodiment of a flow diagram that illustrates producing a software license key to grant licensing rights for digital content;

FIG. 6 depicts an example embodiment of a flow diagram that illustrates a video game system distributing and tracking royalties of digital game content;

FIG. 7 depicts an example embodiment of a digital content management system that may be adapted to distribute and track royalties;

FIG. 8 depicts an example embodiment of a flow diagram that illustrates a digital game content management system distributing and tracking royalties of a digital game content; and

FIG. 9 shows an exemplary computing environment in which aspects of the example embodiments may be implemented.

### DETAILED DESCRIPTION

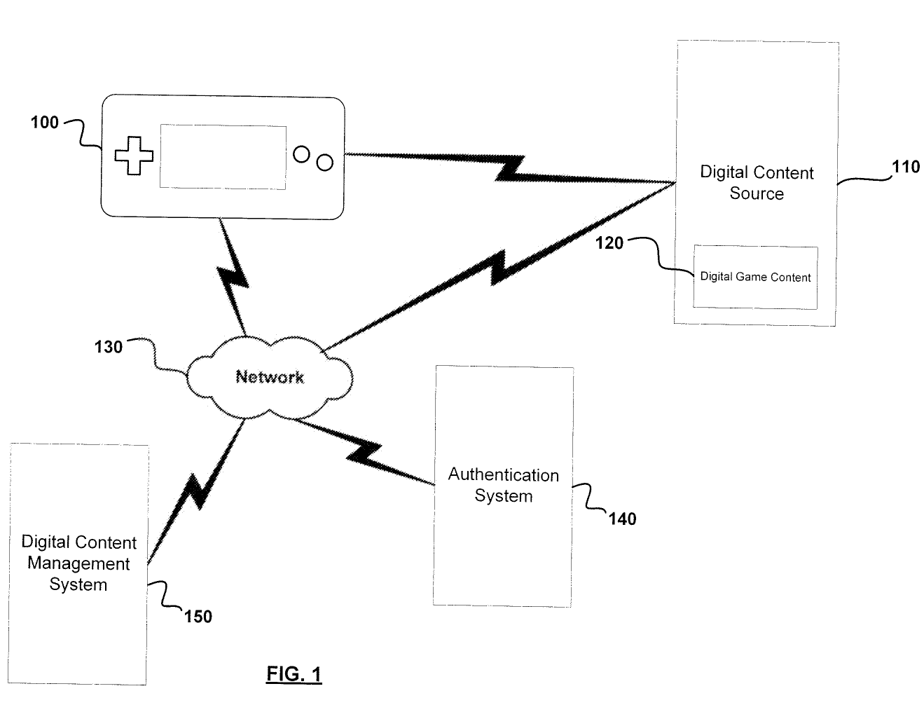

FIG. 1 depicts an example embodiment of a video game system 100 in communication with a digital content source 110 and an authentication system 140. Video game system 100 may be a portable game system. Video game system 100 may include a housing unit with a display screen and number of inputs such as buttons. Video game system 100 may also include a number of hardware components that may reside in the housing unit including a processor, a graphics card, a storage component, a memory component, a memory card reader, an antenna, a communication port, a disc drive, a game cartridge slot, or the like. Video game system 100 may also include software components such as an operating system that may control the hardware components. Video game system 100 may include other suitable components such that a user may play a digital game content 120 such as video games on video game system game 100, for example.

Video game system 100 may be in communication with digital content source 110 via a wired or wireless link. For example, video game system 100 may include a built in wireless antenna such as WiFi wireless LAN port, Bluetooth protocol antenna, or the like to provide a wireless connection to digital content source 110. Additionally, video game system 100 may include a communication port such as an Ethernet port, USB port, Firewire port, or the like that may provide a wired connection to digital content source 110.

Digital content source 110 may provide digital game content 120 such as video games to video game system 100. According to one embodiment, digital content source 110 may include another portable game system. Each portable game system may have a library of digital game content 120 stored in, for example, a storage component. A user of the portable game system of digital content source 110 may wirelessly share digital game content 120 with a user of video game system 100.

For example, a user of a portable game system of digital content source 110 may select digital content 120 from the library to share with a user of video game system 100. A binary file of digital game content 120 may be transferred to and received by video game system 100 via a wireless connection such as WiFi, Infrared, or Bluetooth, for example, or a wired connection such as a USB cord, an Ethernet cord, or the like. The received binary file of digital game content 120 may be stored in a storage component, for example, of video game system 100 such that the user of video game system 100 may access digital game content 120. Digital game content 120 may include a demonstration version of a particular game. For example, digital game content 120 may be transmitted to video game system 100 without an electronic credential such as a digital certificate or license key. When the user of video game system 100 launches or activates digital content source 120, video game system 100 may check for the electronic credential such that the licensing rights of digital game content 120 may be authenticated. If no electronic credential may be stored in video game system 100, the user may access the demonstration version of digital game content 120, which will be described in more detail below.

According to an example embodiment, digital content source 110 may include an online game provider. For example, digital content source 110 may include an online game store that provides a library of digital game content 120. Digital game content 120 may be purchased by a user of video game system 100 from digital game content source 110. For example, a user of the digital content source 110 may select and purchase digital content 120 from the library. Video game system 100 and digital content source 110 may include a wireless connection such as WiFi, Infrared, or Bluetooth, for example, or a wired connection such as a USB cord, an Ethernet cord, or the like connected to a modem in communication with a network 130. After purchasing, a binary file of the selected digital game content 120 may be transferred to video game system 100 from digital content source 110 via network 130. According to one embodiment, digital game content 120 may be transferred directly to video game system 100. Alternatively, digital game content 120 may be downloaded from digital content source 110 to a computer or to a second video game system. Video game system 100 may be connected to the computer or the second video game system such that the downloaded digital game content 120 may be transferred to video game system 100 from the computer or the second video game system. For example, digital game content 120 may be synchronized to video game system 100 via the computer or the second video game system. The received binary file of digital game content 120 may be stored in a storage component, for example, of video game system 100 such that the user of video game system 100 may access digital game content 120.

Digital game content source 110 may also include a retail store. For example, a user of video game system 100 may purchase a physical media such as a disc or cartridge, for example, that may include digital game content 120 at a retail store. According to one embodiment, a computer or a second video game system may be used to digitally extract digital game content 120 purchased at the retail store. The physical media may be inserted into the computer or the second video game system such that the computer or second video game system digitally extracts a binary file of digital game content 120 from the physical media. Video game system 100 may be connected to the computer or the second video game system such that the digitally extracted digital game content 120 may be transferred to video game system 100 from the computer and/or the second video game system. For example, digital game content 120 may be synchronized to video game system 100 via the computer or the second video game system. Additionally, the user may insert the physical media into video game system 100. Video game system 100 may digitally extract digital game content 120 from the physical media into a binary file of digital game content 120. The binary file of digital game content 120 may be stored in a storage component, for example, of video game system 100 such that the user of video game system 100 may access digital game content 120.

According to an example embodiment, digital game content source 110 may include a retail kiosk, for example. The retail kiosk may be set up in a retail store, an airport, a restaurant, or the like. The retail kiosk may include a housing unit with an input device such as a touch screen, a keyboard, or push buttons, for example. The input device may be in operative communication with a computer residing in the housing unit. The computer may have access to a library of digital game content 120. The computer may store digital game content 120 locally in a storage component. The computer may also retrieve digital game content 120 via a network such as network 130. The retail kiosk may include a wired communication component such as USB cable, a Firewire cable, an Ethernet Cable, or the like. The retail kiosk may include a wireless communication component such as WiFi wireless LAN port, an Infrared port, Bluetooth protocol antenna, or the like. Video game system 100 may be connected to the retail kiosk via the wired communication component or the wireless communication component such that digital game content 120 may be transferred to video game system 100 from the retail kiosk. The binary file of digital game content 120 may be stored in a storage component, for example, of video game system 100 such that the user of video game system 100 may access digital game content 120.

Digital game content 120 may include a binary file of a video game that may be compatible and accessed by a user of video game system 100. Digital game content 120 may be accessed according to a licensing right such as a full version, demonstration version, limited assets version, and limited time version, for example. The full version of digital game content 120 may include unlimited access to digital game content 120. For example, a user may launch the full version of digital game content 120 stored in video game system 100. The full version may provide the user with unlimited playing rights. The demonstration version may include limited access to digital game content. For example, the demonstration version may allow a user to open the binary file of digital game content 120 a certain number of times. The limited asset version may include access to certain characters or certain levels in digital game content 120. Additionally, the limited time version may provide a user unlimited access for a set period of time such as a week, for example. The licensing rights afforded to digital game content 120 may depend upon a license key that may be entered by a user of video game system 100 or received by video game system 100 and an electronic credential that may be generated based on the license key, which will be described in more detail below.

Video game system 100 may be in communication with authentication system 140 via network 130. Authentication system 140 may be used to generate license keys, authenticate license keys entered by user of video game system 100, and provide electronic credentials to video game system 100 granting licensing rights to access digital game content 120. For example, authentication system 140 may generate unique license keys. The license keys may include a unique identifier such as a unique number. The unique identifier may be used to activate digital game content 120 according to the version of digital game content 120 purchased. For example, the unique identifier may start with a specific number to indicate whether a full version of digital game content 120 may have been purchased. Alternatively, the unique identifier may include a specific number sequence to indicate whether certain levels and/or character limitations in a limited assets version have been purchased. The license keys may be distributed via a license card to retailers or the license keys may be purchased from online retail stores, for example.

After distribution, a user may purchase a license key from the retailer or online game provider, for example. The user may launch digital game content 120 stored in video game system 100. Digital game content 120 may default in demonstration version, for example. Upon launching digital game content 120, the user may enter the purchased license key. Video game system 100 may generate a package of data information that includes the license key. The package of data information may also include a retail key, a title key corresponding to the designation, title, or the like of digital game content 120, and a system key corresponding to a unique identifier for video game system 100. The package of data information may be encrypted by video game system 100 such that the license key, retail key, title key, system key, and other data information may be obscured if intercepted during transmission to authentication system 140.

The package of data information may be transmitted to authentication system 140 from video game system 100 via network 130. For example, video game system 100 may provide a connection to authentication system 140 via network 130. After receiving the package of data information, authentication system 140 may unencrypt the package of data information if appropriate. Authentication system 140 may then authenticate the license key by comparing the license key with license keys generated by authentication system 140.

Authentication system 140 may then generate an electronic credential such as a digital certificate, for example, that grants licensing rights and access to digital game content 120 corresponding to the purchased license key. The electronic credential may then be transmitted to video game system 100. Video game system 100 may store the electronic credential. The electronic credential may then be used by video game system 100 to unlock digital game content 120 from a demonstration version such that the electronic credential may grant unlimited or limited access to digital game content 120 based on full version, limited asset version, limited time version, or the like.

Authentication system 140 may include hardware components such as a processor, storage components, databases, or the like and/or software components to control the hardware components such that authentication system 140 may generate license keys, authenticate license keys entered by user of video game system 100, and provide electronic credentials to video game system 100 based on the license keys, which will be described in more detail below. Thus, according to one embodiment, digital content source 110 and authentication system 140 may provide digital game content 120 decoupled from licensing rights to access digital game content 120.

According to an example embodiment, video game system 100 may also be in communication with a digital game content management system 150. Digital game content management system 150 may provide digital game content via a number of digital game content transaction options. Additionally, digital game content management system 150 may receive a package of data information including the retail key, title key, and license key from video game system 100 to calculate a royalty amount. The retail key may include a retailer such that the royalty amount may be distributed to the retailer. Digital game content management system 150 may include hardware components such as a processor, storage components, databases, or the like and software components to control the hardware components such that digital game content management system may provide digital game content transaction options and may compute royalties to distribute to the retailer, which will be described in more detail below.

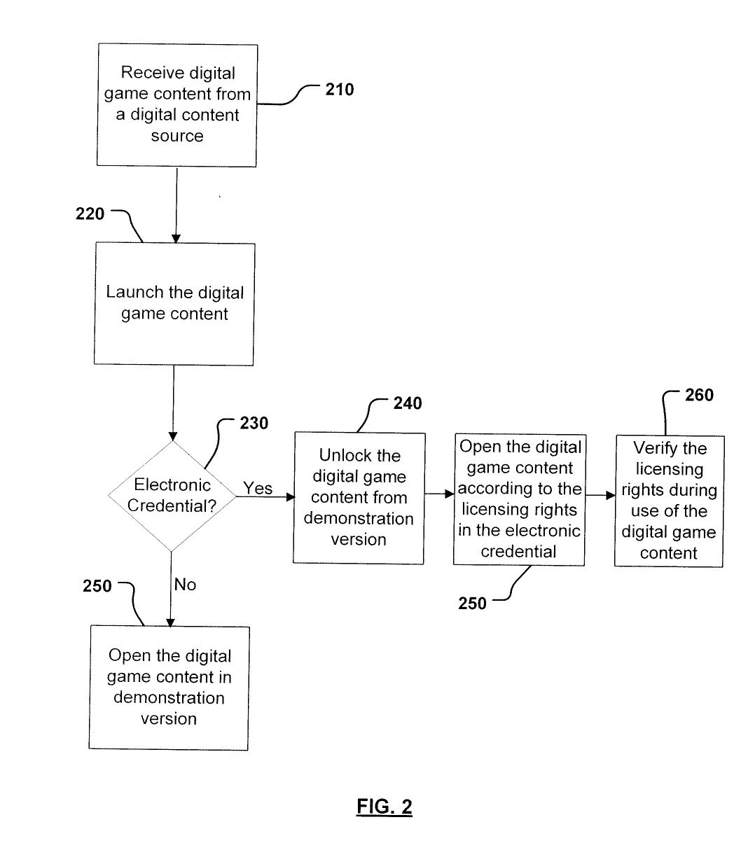

FIG. 2 depicts an example embodiment of a flow diagram that illustrates providing digital game content to a portable gaming device. As shown in FIG. 2, at 210, a portable game system may receive a digital game content from a digital content source. According to one embodiment, the portable game system may receive a binary file of the digital game content. The portable game system may include a housing unit with a display screen and number of inputs such as buttons. The portable game system may also include a number of hardware components that may reside in the housing unit including a processor, a graphics card, a storage component, a memory component, a memory card reader, an antenna, a communication port, a disc drive, a game cartridge slot and the like and software components such as an operating system that may control the hardware components. The digital content source may include a second portable game system. The digital content source may also include a retail store that may provide physical media of the digital game content that may be digitally extracted and synchronized to the portable game system. The digital game content source may also include an online game provider such as an online store, a retail kiosk, or the like. The digital game content may include a full version, a demonstration version, a limited asset version, a limited time version, or the like and may be stored in a storage component in the portable game system, for example.

At 220, a user of the portable game system may launch or activate the digital game content stored in the portable game system. After the digital game content may be launched, at 230, the portable game system may check for an electronic credential such as a digital certificate stored in the storage component. The electronic credential may be used to access digital game content according to licensing rights purchased via the license key.

If an electronic credential may be present in the storage component, at 240, the digital game content may be unlocked or changed from a demonstration version. For example, the digital game content may be unlocked or changed from the demonstration version to the full version, the limited asset version, the limited time version, or the like.

Then, at 250, the digital game content may be opened and accessed according to licensing rights in the electronic credential. For example, the digital game content may have unlimited access according to the full version or limited access according to the limited assets version, the limited time version, or the like. At 260, the licensing rights to access the digital game content may be verified while the digital game content may be opened. For example, the portable game system may check for the electronic credential to ensure licensing rights have not changed while the digital game content may be opened or played.

If an electronic credential may not be present in the storage component, at 270, the digital game content may be opened in a demonstration version. The demonstration version may include limited access to digital game content. For example, the demonstration version may allow a user to open the binary file of the digital game content a certain number of times.

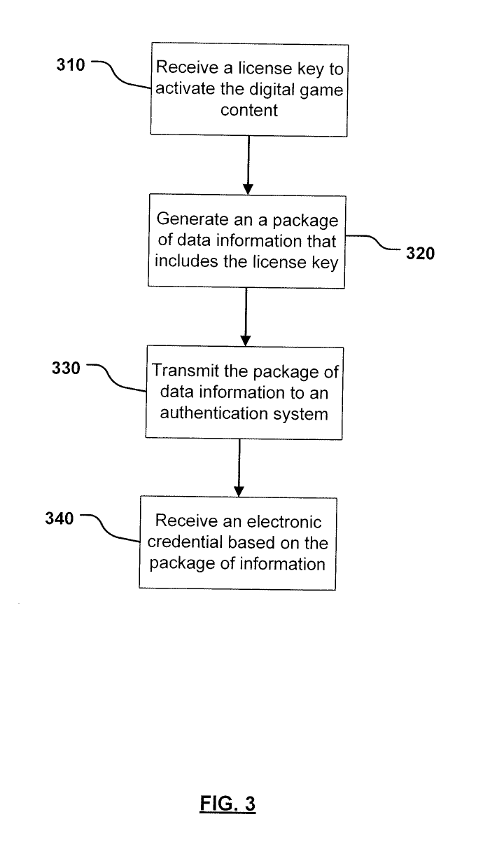

FIG. 3 depicts an example embodiment of a flow diagram that illustrates providing an electronic credential to the portable game system. As shown in FIG. 3, at 310, the portable game system may receive a license key to activate the digital game content. The license key may be received by the portable game system when a user inputs the license key. Additionally, the license key may be received by the portable game system via an electronic transfer from a retail kiosk, a video game system, a computer, a network connection, an online game provider, or the like. Additionally, the license key may be received with the digital game content. The license key may include a unique number or identifier that may be used to generate an electronic credential that may provide licensing rights to access the digital game content. For example, the unique number may provide unlimited or limited access to the digital game content.

At 320, a package of data information may be generated by the portable game system. The package of data information may include a license key, a retail key, a title key, and a system key, for example. Additionally, the package of data information may be encrypted when entered into the portable game system such that the license key, retail key, title key, and system key may be obscured if intercepted during transmission to an authentication system.

At 330, the package of data information may be transmitted via a network to the authentication system. The authentication system may include hardware components such as a processor, storage components, databases, or the like and software components to control the hardware components. The authentication system may receive the package of data information and unencrypt it if appropriate. The authentication system may then authenticate the license key by comparing the license key with license keys generated by the authentication system. Then, the authentication system may generate an electronic credential based on the package of data information.

At 340, the portable game system may receive the electronic credential generated by the authentication system. The electronic credential may be used to grant licensing rights to access the digital game content stored in the portable game system. For example, the electronic credential may unlock the digital game content from a demonstration version. Additionally, the portable game system may check for the electronic credential while the digital game content may be opened.

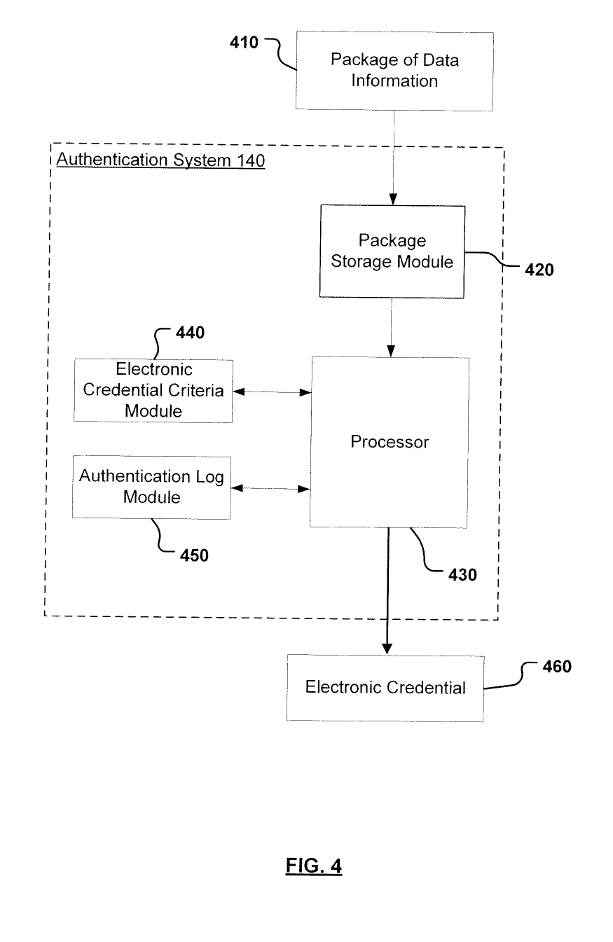

FIG. 4 depicts an example embodiment of authentication system 140 that may be adapted to generate and manage licensing rights of digital game content. Authentication system 140 may include a package storage module 420. Package storage module 420 may include a memory storage component such as a hard drive, Random Access Memory (RAM), a database, or the like. Package storage module 420 may received a package of data information 410 from a video game system such as video game system 100, shown in FIG. 1. Package of data information 410 may include a license key, a retail key, a title key, a system key, or the like. According to one embodiment, package of data information 410 may be encrypted, thus, authentication system 140 may unencrypt package of data information if appropriate.

Authentication system 140 may also include an electronic credential module 440. Electronic credential module 440 may include a database, a hard drive, Random Access Memory (RAM), or the like, for example. Electronic credential module 440 may store one or more criteria. The criteria may include rules that may be used to determine whether an element in package of data information 410 such as the license key may be authentic, for example. Electronic credential module 440 may include a database of valid license keys that may be used to verify a license key in package of data information 410, for example.

According to one embodiment, authentication system 140 may include a processor 430 in operative communication with package storage module 420 and electronic credential criteria module 440. Processor 430 may include a typical computer processor such that processor 430 may interpret instructions and process data. Processor 430 may compare package of data information 410 stored in package storage module 420 with criteria stored in electronic credential module 440. If an element in package of data information 410 stored in package storage module 420 matches criteria stored in electronic credential module 440, processor 430 may generate an electronic credential 460. For example, processor 430 may compare the license key in package of data information 410 with a database of valid license keys in electronic credential module 440 such that processor 430 may generate electronic credential 460 if the license key in package of data information 410 matches a valid license key in the database. Electronic credential 460 may include a digital certificate, for example, such that electronic credential 460 may provide licensing rights to access digital game content 120, shown in FIG. 1. Processor 430 may also transmit electronic credential 460 to video game system 100 via network 130, as shown in FIG. 1.

Authentication system 140 may further include an authentication log module 450 in operative communication with processor 430. Authentication log module 450 may include a memory storage component such as a hard drive, Random Access Memory (RAM), a database, or the like, for example. Authentication log module 450 may store a unique history log based on package of data information 410 and generated electronic credential 460. Authentication log module 450 may be used to renew electronic credential 460 if digital game content 120, shown in FIG. 1, may be damaged. For example, package of data information 410 may include a license key, retail key, title key, and system key from a previous package of data information. Processor 430 may compare package of data information 410 with the criteria in electronic credential module 440 and the unique history log stored in authentication log module 450. Processor 430 may re-generate electronic credential 460 if the criteria, the unique history log, and at least one element in package of data information 410 match.

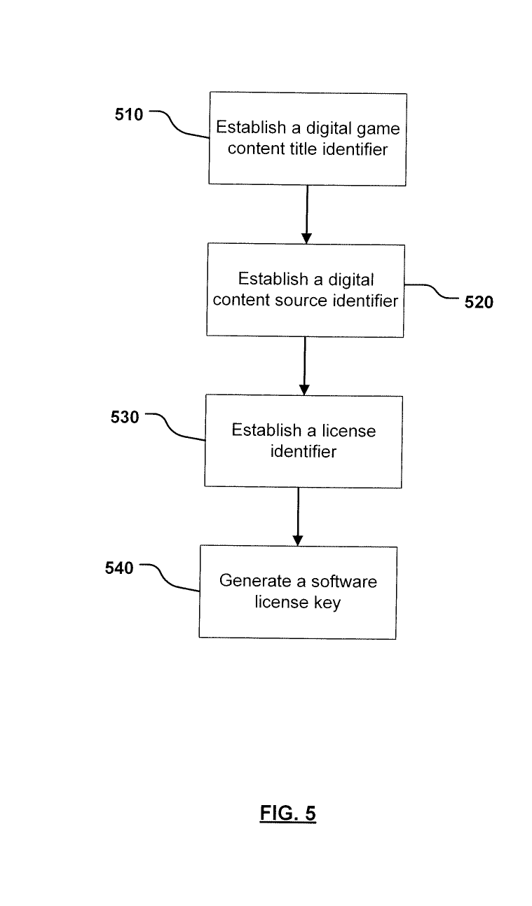

FIG. 5 depicts an example embodiment of a flow diagram that illustrates producing a software license key to establish licensing rights for digital game content. As shown in FIG. 5, at 510, a digital rights management system or authentication system, for example, may establish a digital game content title identifier. The digital game content title identifier may include a unique identifier such as a unique number, for example, of a designation, title, or the like corresponding to a digital game content that may be purchased.

At 520, the authentication system may establish a digital content source identifier. The digital content source identifier may include a unique identifier such as a unique number, for example. The digital content source identifier may be used to identify where the produced software license key may be distributed. For example, the digital content source identifier may include a unique number corresponding to the retailer where the software license key may be sold.

At 530, the authentication system may establish a license identifier. The license identifier may include a unique identifier such as a unique number, for example. The license identifier may be used to identify the licensing right that may be granted when the produced software key may be purchased.

At 540, the authentication system may generate a software license key based on the digital game content title identifier, the digital source identifier, and the license identifier. The software license keys may include a unique identifier such as a unique number. The unique identifier may be a combination of the unique identifiers of the title identifier, the digital source identifier, and the license identifier. The software license key may be distributed to retail stores, online stores, or the like such that a user can purchase the software license key and enter it into a portable game system to activate digital game content stored in the portable game system.

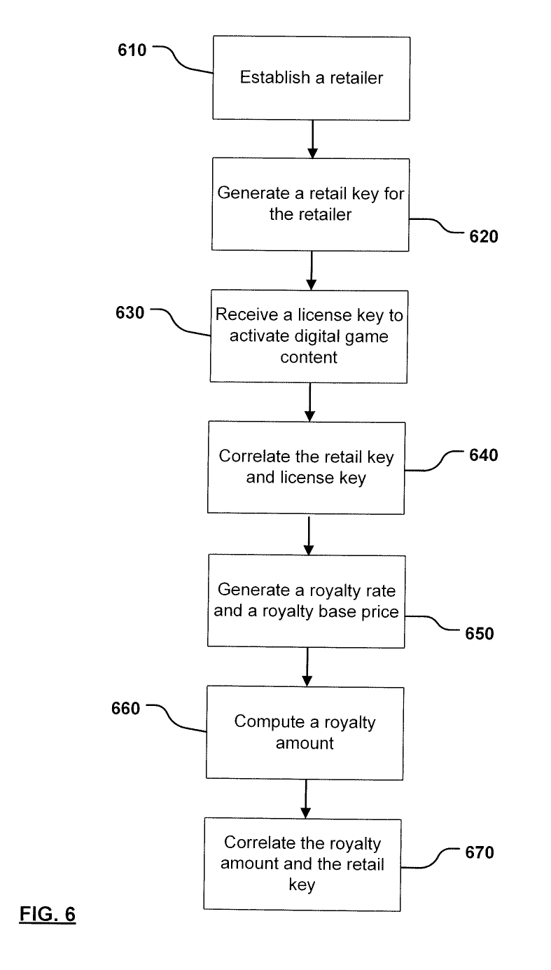

FIG. 6 depicts an example embodiment of a flow diagram that illustrates video game system distributing and tracking royalties of digital game content. As illustrated in FIG. 6, at 610, a video game system may establish a retailer. The video game system may include a housing unit with a display screen and number of inputs such as buttons. The video game system may also include a number of hardware components that may reside in the housing unit including a processor, a graphics card, a storage component, a memory component, a memory card reader, an antenna, a communication port, a disc drive, a game cartridge slot and the like and software components such as an operating system that may control the hardware components.

According to one embodiment, a user of the video game system may select a retailer. Alternatively, the retailer may be tied to the video game system. For example, the retailer may include the retailer or retail store where the video game system may have been purchased. The retailer may be stored in the video game system.

At 620, the video game system may generate a retail key for the retailer. The retail key may include a unique identifier such as a unique number that may correspond to the retailer. For example, each retailer may have its own unique number assigned thereto.

At 630, the video game system may receive a license key to activate a binary file of the digital game content. The license keys may include a unique identifier such as a unique number. The unique identifier may be used to the activate digital game content according to a purchased version of digital game content such as full version, limited asset version, limited time version, or the like of the digital game content purchased.

At 640, the video game system may correlate the retail key and the license key. Additionally, the video game system may correlate a title key with the retail key and the license. The title key may include a unique identifier such as a unique number corresponding to a designation, title, or the like of the digital game content. The correlated license key, retail key, and title key may be encrypted when entered into the video game system such that the license key, retail key, and title key may be obscured. In one embodiment, the correlated license key, retail key, and title key may be transmitted to a digital content management system that may calculate, process, and distribute royalties.

At 650, the video game system may generate a royalty rate based on the license key and a royalty price based on the title key. For example, the video game system may include a storage component that includes royalty rates indexed by license keys and royalty prices indexed by the title keys. Thus, the processor may access the storage component in the video game system to generate a royalty rate and a royalty base price.

Then, at 660, the video game system may compute a royalty amount. For example, the processor in the video game system may compute the royalty amount. According to one embodiment, the royalty amount may be computed by multiplying the royalty rate and the royalty price.

After computing the royalty amount, at 670, the royalty amount and the retail key may be correlated. The correlated royalty amount and retail key may be encrypted when entered into the video game system such that the royalty amount and the retail key may be obscured if intercepted during transmission to an a royalty computation system. The correlated royalty amount and retail key may be transmitted to the royalty computation system that may distribute the royalty amount to a retailer corresponding to the unique identifier in the retail key.

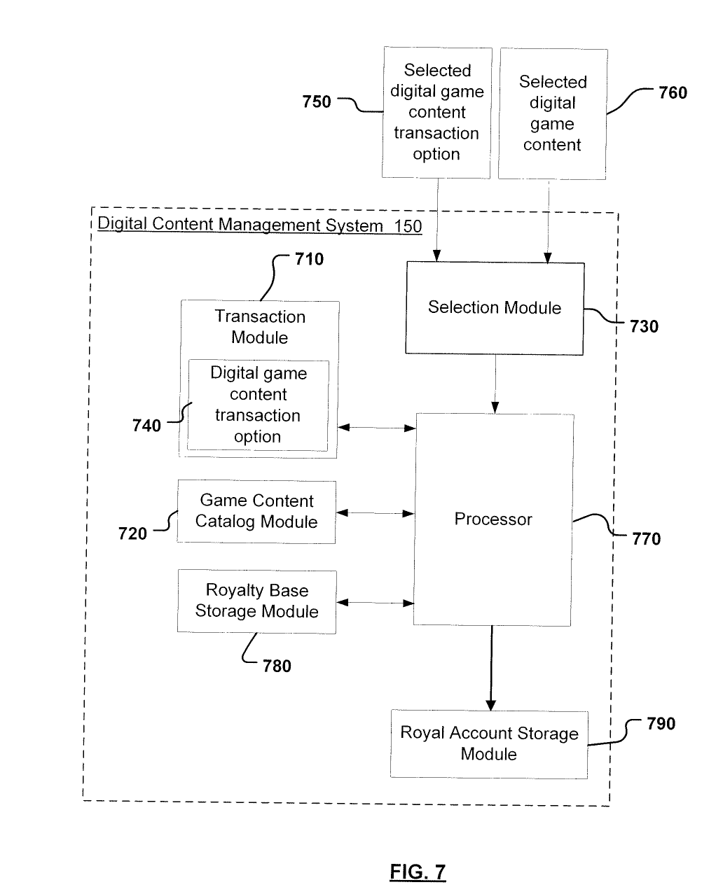

FIG. 7 depicts an example embodiment of digital content management system 150 that may be adapted to distribute and track royalties. As illustrated in FIG. 7, digital game content management system 150 may include a transaction module 710, a game content catalog module 720, and a selection module 730. Transaction module 710 may include a hard drive, a database, Random Access Memory (RAM), or the like such that transaction module 710 may be adapted to provide a digital game content transaction option 740. Digital game content transaction option 740 may include a per instance rental, a per instance purchase, a monthly rental, a retail affiliated purchase, and a gift purchase. The per instance rental may include renting a digital game content for a period of time such as week at which point the electronic credential expires or renting a digital game content until the digital game content may be checked back into the digital game content management system. The per instance purchase may include paying a one time fee to purchase a digital game content. The monthly rental may include paying a monthly fee to rent a number of digital game contents. The retailed affiliated purchase may include an online price information page that may allow a digital game content to be purchased from the lowest priced retailer. The gift purchase may include purchasing a digital game content that may be a gift for another person. Thus, according to an example embodiment, digital game content transaction option 740 may include any number of distribution techniques such that a user of video game system 100, shown in FIG. 1, may receive digitally distributed game content.

Transaction module 710 may also include a royalty rate that may correspond to digital game content transaction option 740. The royalty rate may vary depending upon digital game content option 740. For example, a royalty rate may be a small percentage such as 1%, for example, for a per instance rental, but may be a larger percentage such as 5%, for example, for a per instance purchase. Thus, according to one embodiment, the royalty rate may be a function of digital game content transaction option 740.

Game content catalog module 720 may include a hard drive, database, Random Access Memory (RAM), or the like, such that game content catalog module 720 may be adapted to provide digital game content. Game content catalog module 720 may include a library of digital game content such as video games. Game content catalog module 720 may provide the digital game content according to digital game content transaction option 740 selected by a user of video game system 100, shown in FIG. 1.

Selection module 730 may include a hard drive, database, Random Access Memory (RAM), or the like, such that selection module 730 may be adapted to receive and store a selected digital game content transaction option 750 corresponding to one of digital game content options 740 and a selected digital game content 760 stored in game content catalog module 720, for example. Selection module 730 may also receive and store a retailer. The retailer may be selected by a user of video game system 100, shown in FIG. 1. Alternatively, the retailer may be tied to the retailer where video game system 100, shown in FIG. 1, may have been purchased. The retailer may include a unique identifier such as a unique number such that the retailer may receive royalties based on the digital game content that may be purchased or rented, for example.

According to one embodiment, digital game content management system 150 may also include a processor 770 and royalty base storage module 780. Royalty base storage module 780 may include a hard drive, database, Random Access Memory (RAM), or the like, such that royalty base storage module 780 may store a royalty base price corresponding to the digital game content in game content catalog module 720. For example, royalty base storage module 780 may store the royalty base price for each of the digital game contents stored in game content catalog module 720.

Processor 770 may include a typical computer processor such that processor 430 may interpret instructions and process data. Processor 770 may be in operative communication with transaction module 710, game content catalog module 720, and selection module 730. Processor 770 may generate a royalty rate based on selected digital game content transaction option 750 and a royalty base price based on selected digital game content 760, for example. For example, processor 770 may generate a royalty rate from transaction module 710 and the royalty base price from royalty base storage module 780. Processor 770 may compute a royalty amount by multiplying the royalty rate by the royalty base price.

Digital game content management system 150 may further include a royalty account module 790 in operative communication with processor 770. Royalty account module 790 may include a hard drive, database, Random Access Memory (RAM), or the like, such that royalty account module 790 may store the royalty amount computed by the processor 770. According to one embodiment, royalty account module 790 may include a database indexed by the preferred retailer such that the royalty amount may be stored in royalty account module 790 based on the unique identifier of the preferred retailer. Royalty account module 790 may also include a cumulative royalty amount stored therein. According to one embodiment, processor 770 may add the computed royalty amount to the cumulative royalty amount and store that new cumulative royalty amount in royalty account module 790. Additionally, the cumulative royalty amount stored in royalty account module 790 may be distributed to the preferred retailer at the end of an accounting period, for example.

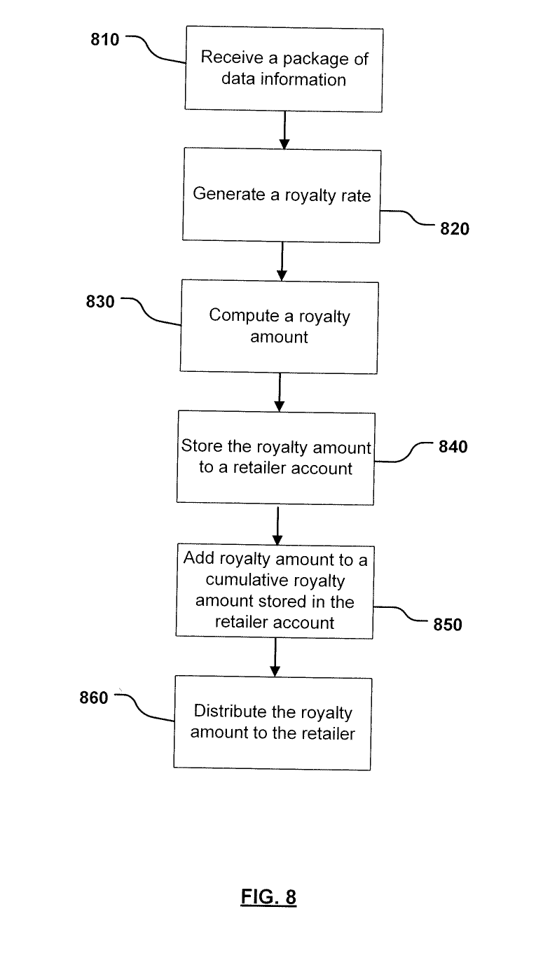

FIG. 8 depicts an example embodiment of a flow diagram that illustrates the digital game content management system distributing and tracking royalties of a digital game content. As shown in FIG. 8, at 810, a digital game content management system may receive a package of data information that may include a title key, a retail key, and a license key. The digital game content management system may include hardware components such as a processor, storage components, databases, or the like and software components to control the hardware components such that digital game content management system may provide digital game content transaction options and may compute royalties to distribute to a preferred retailer. The package of data information may be received from video game system 100, shown in FIG. 1, for example.

At 820, after receiving the package of data information, the digital game content management system may generate a royalty rate based on the received license key and a royalty base price based on the received title key. For example, the license key may include a unique identifier such as a unique number based on a licensing right and a digital game content transaction option. The licensing right may include a full version, a demonstration version, a limited assets version, and a limited time version, for example. The digital game content transaction option may include a per instance rental, a per instance purchase, a monthly rental, a retail affiliated purchase, and a gift purchase. The royalty rate may be generated based on the licensing right and the digital game content transaction option represented by the unique identifier in the license key. For example, a royalty rate may be small such as 1%, for example, for a per instance rental and a limited assets version and larger such as 5%, for example for a per instance purchase and a full version. Thus, according to one embodiment, the royalty rate may be a function of the digital game content option and the licensing right.

Additionally, the royalty base price may be generated based on the received title key. For example, the title key may include a unique identifier such as a unique number based on a designation, title, or the like of the digital game content received by the video game system by purchase, rental, or the like. According to one embodiment, the royalty base price may depend upon the designation, title, or the like of the digital game content. For example, each of the digital game contents may have a different purchase price that may be determined by popularity, time of release, or the like. Thus, according to one embodiment, they royalty base price may depend upon the title of the digital game content.

At 830, the digital game content management system may compute a royalty amount. The royalty amount may be computed by multiplying the royalty rate and the royalty base price generated at 820.

Then, at 840, the royalty amount may be stored to a retailer account corresponding to the received retail key in the digital game content management system. The retail key may include a unique identifier such as a unique number based on a preferred retailer. According to one embodiment, a user of the video game system may select a preferred retailer that may be stored in the video game system. Alternatively, the preferred retailer may be tied to the video game system. For example, the preferred retailer may include the retailer or retail store where the video game system may have been purchased.

According to an example embodiment, at 850, the royalty amount may be added to a cumulative royalty amount stored in the retailer account. The cumulative royalty may include a cumulative total amount of royalties entitled to the preferred retailer.

The cumulative royalty amount may be distributed to the preferred retailer at 860. For example, after a predetermined reporting period such as at the end of an accounting or reporting period, or the like, the cumulative royalty amount may be distributed to the preferred retailer.

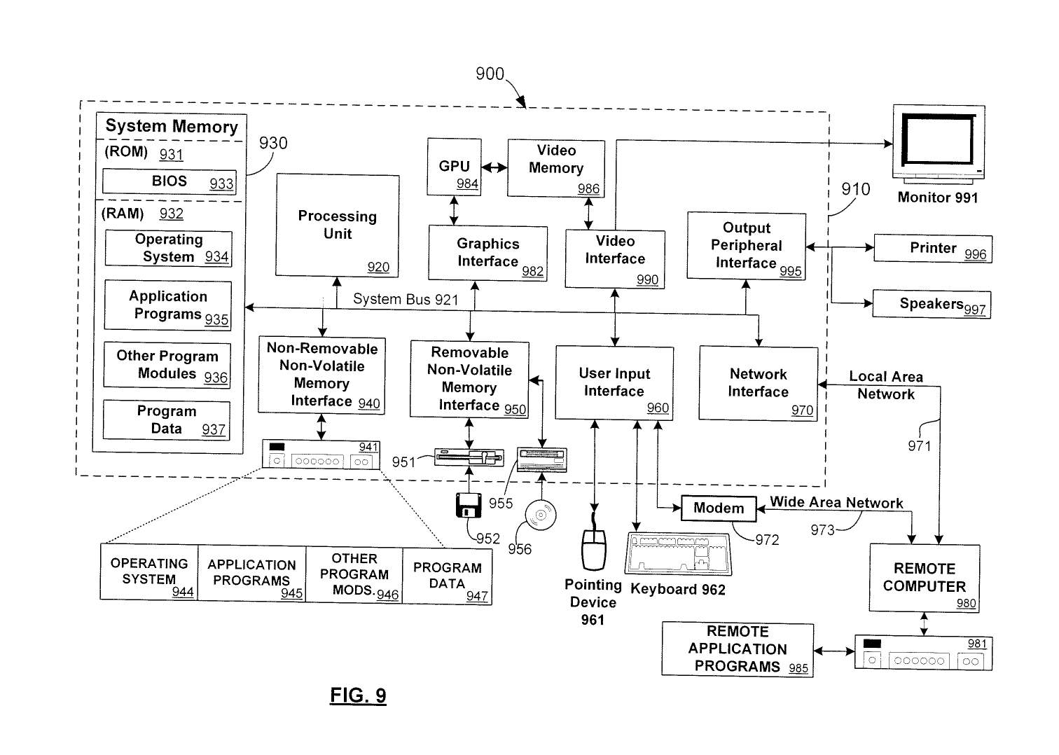

FIG. 9 shows an exemplary computing environment in which aspects of the example embodiments may be implemented. Computing system environment 900 is only one example of a suitable computing environment and is not intended to suggest any limitation as to the scope of use or functionality of the described example embodiments. Neither should computing environment 900 be interpreted as having any dependency or requirement relating to any one or combination of components illustrated in exemplary computing environment 900.

The example embodiments are operational with numerous other general purpose or special purpose computing system environments or configurations. Examples of well known computing systems, environments, and/or configurations that may be suitable for use with the example embodiments include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

The example embodiments may be described in the general context of computer-executable instructions, such as program modules, being executed by a computer. Generally, program modules include routines, programs, objects, components, data structures, etc. that perform particular tasks or implement particular abstract data types. The example embodiments also may be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 9, an exemplary system for implementing the example embodiments includes a general purpose computing device in the form of a computer 910. Components of computer 910 may include, but are not limited to, a processing unit 920, a system memory 930, and a system bus 921 that couples various system components including the system memory to processing unit 920. Processing unit 920 may represent multiple logical processing units such as those supported on a multi-threaded processor. System bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). System bus 921 may also be implemented as a point-to-point connection, switching fabric, or the like, among the communicating devices.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

System memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

Computer 910 may also include other removable/non-removable, volatile/nonvolatile computer storage media. By way of example only, FIG. 6 illustrates a hard disk drive 940 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Hard disk drive 941 is typically connected to system bus 921 through a non-removable memory interface such as interface 940, and magnetic disk drive 951 and optical disk drive 955 are typically connected to system bus 921 by a removable memory interface, such as interface 950.

The drives and their associated computer storage media discussed above and illustrated in FIG. 9, provide storage of computer readable instructions, data structures, program modules and other data for computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to processing unit 920 through a user input interface 960 that is coupled to the system bus, but may be connected by other interface and bus structures, such as a parallel port, game port or a universal serial bus (USB). A monitor 991 or other type of display device is also connected to system bus 921 via an interface, such as a video interface 990. In addition to the monitor, computers may also include other peripheral output devices such as speakers 997 and printer 996, which may be connected through an output peripheral interface 995.

Computer 910 may operate in a networked environment using logical connections to one or more remote computers, such as a remote computer 980. Remote computer 980 may be a personal computer, a server, a router, a network PC, a peer device or other common network node, and typically includes many or all of the elements described above relative to computer 910, although only a memory storage device 981 has been illustrated in FIG. 9. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, computer 910 is connected to LAN 971 through a network interface or adapter 970. When used in a WAN networking environment, computer 910 typically includes a modem 972 or other means for establishing communications over WAN 973, such as the Internet. Modem 972, which may be internal or external, may be connected to system bus 921 via user input interface 960, or other appropriate mechanism. In a networked environment, program modules depicted relative to computer 910, or portions thereof, may be stored in the remote memory storage device. By way of example, and not limitation, FIG. 9 illustrates remote application programs 985 as residing on memory device 981. It will be appreciated that the network connections shown are exemplary and other means of establishing a communications link between the computers may be used.

Computing environment 900 typically includes at least some form of computer readable media. Computer readable media can be any available media that can be accessed by computing environment 900. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing environment 900. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of tracking royalties for a digital game content in a video game system, the method comprising:
establishing a retailer;
generating a retail key for said retailer;
receiving a license key to activate said digital game content; and
correlating said retail key and said license key.

2. The method of claim 1, further comprising a title key corresponding to a designation of said digital game content correlated with said retail key and said license key.

3. The method of claim 2, further comprising:
generating a royalty rate based on said license key and a royalty price based on said title key;
computing a royalty amount by multiplying said royalty rate and said royalty base price; and
correlating said royalty amount and said retail key.

4. The method of claim 1, wherein said retailer comprises a retailer selected by a user of said video game system.

5. The method of claim 1, wherein said retailer includes a retailer who sells said video game system.

6. A method of tracking royalties for a digital game content in a video game system, the method comprising:
receiving a package of data information including a title key, a retail key, and a license key;
generating a royalty rate based on said received license key and a royalty base price based on said received title key;
computing a royalty amount by multiplying said royalty rate and said royalty base price; and
storing said royalty amount to a retailer account corresponding to said retail key.

7. The method of claim 6, wherein said license key includes a unique identifier based on a licensing right and a digital game content transaction option.

8. The method of claim 7, wherein said royalty rate varies based on said licensing right and said digital game content transaction option in said license key.

9. The method of claim 8, wherein said licensing right includes at least one of the following: a full version, a demonstration version, a limited assets version, and a limited time version.

10. The method of claim 8, wherein said digital game content transaction option includes at least one of the following: a per instance rental, a per instance purchase, a monthly rental, a retail affiliated purchase, and a gift purchase.

11. The method of claim 6, wherein said retail key includes a unique identifier for a retailer.

12. The method of claim 11 further comprising:
adding said royalty amount to a cumulative royalty amount stored in said retailer account corresponding to said unique identifier for said retailer; and
distributing said cumulative royalty amount stored in said retailer account to said retailer.

13. The method of claim 12, wherein said cumulative royalty amount stored in said retailer account is distributed to said retailer after a predetermined reporting period.

14. A digital game content management system that provides royalties to a retailer based on a digital game content, the system comprising:
a transaction module adapted to provide a digital game content transaction option;
a game content catalog module adapted to provide digital game content;
a selection module adapted to receive a selected digital game content transaction option and a selected digital game content from a user; and
a processor in operative communication with said transaction module, said game content catalog module, and said selection module, wherein said processor computes a royalty amount based on said selected digital game content transaction option and said selected digital game content.

15. The system of claim 14 further comprising royalty base storage module in operative communication with said processor, wherein said royalty storage module stores a royalty base price corresponding to said digital game content.

16. The system of claim 15, wherein said selected digital game content option provides a royalty rate, and wherein said processor computes said royalty amount by multiplying said royalty rate by said royalty base price.

17. The system of claim 14, wherein said selection module receives a retailer.

18. The system of claim 17, further comprising a royalty account module, wherein said royalty account module stores said royalty amount.

19. The system of claim 18, wherein said royalty account module indexes said royalty amount to said retailer.

20. The system of claim 14, wherein said digital game content transaction option includes at least one of the following: a per instance rental, a per instance purchase, a monthly rental, a retail affiliated purchase, and a gift purchase.
